(19) United States
(12) Patent Application Publication
(10) Pub. No.: US 2013/0337393 A1
(43) Pub. Date: Dec. 19, 2013

(54) HEAT PROTECTION GLAZING AND METHOD FOR PRODUCING SAME

(71) Applicants: Christian Henn, Frei-Laubersheim (DE); Veit Luther, Hattersheim (DE); Martin Mueller, Darmstadt (DE)

(72) Inventors: Christian Henn, Frei-Laubersheim (DE); Veit Luther, Hattersheim (DE); Martin Mueller, Darmstadt (DE)

(73) Assignee: Schott AG, Mainz (DE)

(21) Appl. No.: 13/824,711

(22) PCT Filed: Sep. 29, 2011
(86) PCT No.: PCT/EP2011/004864

§ 371 Date: Sep. 3, 2013

(30) Foreign Application Priority Data
Sep. 30, 2010 (DE) 10 2010 046 991.2

(51) Int. Cl. C03C 17/23

(52) U.S. Cl. CPC C03C 17/23
USPC 432/120; 427/314; 204/192.26; 65/60.53

(57) ABSTRACT

A heat protection glazing is provided that includes an infrared-reflective coating on temperature resistant substrates, which are transparent in the visible spectral range. The coating is resistant and effective relative to long-term thermal loads.

### SPECIFICATION

The invention generally relates to the field of heat protection glazings. More particularly, the invention relates to heat protection glazings that are provided with infrared-reflective coatings. Heat protection glazings are used, for example, as oven windows and as glass in wood-burning stoves. To reflect infrared radiation back into the hot space of such a unit, it has been known to use transparent, electrically conductive coatings. Suitable, for example, are indium tin oxide and fluorine-doped tin oxide. However, long-term stability of such layers is insufficient, since, generally, due to the exposure to high temperatures the plasma edge of these layers shifts such that reflection efficiency decreases significantly. Moreover, the particularly effective indium tin oxide layers are comparatively expensive to manufacture. Furthermore, the transparency of the layers may change.

EP 1 518 838 B1 discloses an observation window having a multilayer coating for high-temperature applications, such as for glass melting furnaces and incinerators. Indium tin oxide is used as one of the layers as an alternative to metallic titanium. At the same time the coating is intended to have a light-shielding effect, so that a high degree of transparency is not desired here. The transmittance in the visible spectral range is intended to be not more than 10%. Another problem with the durability of coatings arises is the substrate has a small coefficient of thermal expansion. However, it's just a small thermal expansion coefficient that is favorable for temperature-resistant glasses and glass ceramics. With a small coefficient of thermal expansion, the coating may tear or even flake off when the heat protection glazing is heated strongly, due to the differences in the thermal expansion coefficients of the coating and the substrate and the mechanical stresses associated therewith.

Accordingly, there is a need to provide a low cost infrared-reflective coating on temperature resistant transparent substrates, which is stable and effective even under very long lasting thermal loads, but which is transparent in the visible spectral range. This object of the invention is achieved by the subject matter of the independent claims. Advantageous embodiments and modifications of the invention are set forth in the respective dependent claims.

Accordingly, the invention provides a heat protection glazing with a high-temperature infrared reflecting filter coating, wherein the heat protection glazing comprises a glass or glass-ceramic sheet having a linear coefficient of thermal expansion α of less than 4.2*10⁻⁶/K, preferably even less than 3.5*10⁻⁶/K, wherein at least one surface of the glass or glass-ceramic sheet is coated with a titanium dioxide layer which is doped with at least one transition metal compound, preferably a transition metal oxide, so that the titanium dioxide layer has a sheet resistance of not more than 2MΩ, and wherein the titanium dioxide layer has a layer thickness of an optical thickness corresponding to one quarter of the wavelength of the maximum of a black body radiator at a temperature between 400° C. and 3000° C. Surprisingly, it has been found that the titanium dioxide layers doped according to the invention remain free of haze, even in long-term operation under high temperature loads.

The invention further relates to a thermal process unit with a hot space and a window closing the hot space, which comprises a heat protection glazing with a high-temperature infrared reflecting filter coating according to the invention.

The method for producing such a heat protection glazing with a high-temperature infrared reflecting filter coating, accordingly, is based on depositing a titanium dioxide layer doped with a transition metal or a compound of a transition metal on a glass or glass-ceramic sheet, wherein the layer is doped such that it has a sheet resistance of not more than 2MΩ, and with an optical thickness corresponding to one quarter of the wavelength of the maximum of a black body radiator at a temperature between 400° C. and 3000° C. According to a first embodiment of the invention, the coating is deposited on a glass or glass-ceramic substrate having a low linear coefficient of thermal expansion α of less than 4.2*10⁻⁶/K.

According to another embodiment, the low thermal expansion may be obtained by a further process step following the deposition. In particular, ceramization is considered in his case. Accordingly, the titanium dioxide layer is deposited on a glass sheet, and the coated glass sheet is subsequently ceramized, so that a glass-ceramic sheet coated with the doped titanium dioxide layer is obtained that has a linear coefficient of thermal expansion α of less than 4.2*10⁻⁶/K.

Very surprisingly here, the coating according to the invention remains free of haze following ceramization. In accordance with yet another embodiment of the invention it is even possible, to deform the glass or glass-ceramic sheet in a hot-forming step after the high-temperature infrared reflecting filter coating has been deposited. According to a variation of this embodiment of the invention, the doped titanium dioxide layer is deposited on a sheet of ceramizable glass. Such glass sheets of ceramizable glass are also known as green glass sheets. According to this embodiment, hot-forming is accomplished while the sheet softens during ceramization.

Titanium dioxide is a compound semiconductor, and by adding the transition metals, preferably in form of oxides, it is stimulated to provide free carriers. As a result thereof, a conductive coating can be obtained from purely dielectric titanium oxide.

It has been found that the titanium dioxide layers doped with the transition metal or a transition metal compound are very temperature-stable and at the same time do not degrade substantially by a shift of the plasma edge under the operation-related temperature influence in the thermal process unit. Additionally, according to the invention, optical interference of the titanium dioxide layer is exploited, as the layer acts as a λ/4 layer for the infrared radiation incident thereon. Thus, the high-temperature infrared reflecting filter coating according to the invention acts as both as a transparent conductive oxide and as an optical interference reflective layer.

The above-mentioned property of a λ/4 layer for thermal radiation at temperatures between 400° C. and 3000° C. may typically be achieved with a layer thickness ranging from 80 to 750 nanometers, preferably from 80 to 250, more preferably from 100 to 150 nanometers. A layer thickness of 750 nanometers, with typical indices of refraction of the doped layer, corresponds to an optical thickness of λ/4 adapted to a maximum of a spectral intensity distribution of a temperature radiator with a temperature of 400° C. However, layers adapted for higher temperatures, i.e. thinner layers, are preferred. This is partly because the energy content increases as the wavelength decreases, so that an adaptation to smaller wavelengths than that of the maximum of the spectral intensity distribution may be useful.

Good conductivity of the coating may in particular be achieved by replacing cations in the lattice by higher-valence ions, so that electrons are emitted into the conduction band and thus produce conductivity.

Dopants which do not differ too significantly from titanium in shape and size have proven particularly suitable for achieving a high doping efficiency, i.e. a large number of emitted electrons per impurity atom. These conditions are in particular met by compounds of at least one of transition metals Nb, Ta, Mo, V. Among the above mentioned transition metals, niobium and tantalum are especially suitable as a dopant to achieve a low sheet resistance or a high conductivity. When doping with these metals or compounds thereof, electrical resistivities of less than 2*10⁻³ Ω·cm may be achieved, in particular around 1*10⁻³ Ω·cm. The sheet resistance of layers according to the invention may thus be less than 1 kΩ. Such low sheet resistances may possibly also be achieved when using other transition metals or compounds thereof as a dopant.

For depositing the titanium dioxide layer, a sputter process is particularly suitable. The sputter process may comprise reactive sputtering using a metallic target. According to another embodiment a ceramic target is used. The simplest way to incorporate the dopant is to use a target doped with the transition metal. In case of oxidized ceramic targets, this additionally provides for a sufficient conductivity of the target in correspondence with the deposited layer. However, co-deposition from two targets is likewise possible.

A sheet resistance of the titanium dioxide layer of not more than 2 MΩ may typically be obtained by doping with a transition metal compound in an amount from 1 to 10 percent by weight, preferably from 3 to 6 percent by weight. Moreover, with such doping ranges good transparency of the layer is achieved. Higher amounts of doping result in increased occupancy of the interstitial sites and hence in reduction of transparency. For example, a titanium oxide target doped with 1 to 10 percent by weight of niobium oxide may be used for this purpose. Alternatively, the doped titanium dioxide layer may be formed by reactive sputtering in an oxygen containing atmosphere.

Furthermore, it has been found to be particularly advantageous if the titanium dioxide layer contains a crystalline phase. An anatase crystalline phase exhibits particularly favorable properties. This is surprising in that at high temperatures anatase transforms to rutile. As such, one would expect that the anatase-containing layer is less temperature-stable, whereas the deposited layers exhibit a high long-term stability without significant changes in film morphology.

Moreover, anatase-containing layers have proved to be advantageous for their good conductivity that is achievable. It has been found that for the same doping the sheet resistance of an anatase-containing layer is lower than that of for example a rutile-containing layer.

Preferably, however, the titanium dioxide layer is not purely crystalline. Rather, best results in terms of temperature stability and conductivity were obtained when the titanium dioxide layer also included an X-ray amorphous phase. This, again, is surprising, since one could assume that the equilibrium between the phases might change due to the influence of temperature. So, according to a particularly advantageous embodiment of the invention, the titanium dioxide layer contains a crystalline phase and an X-ray amorphous phase, to achieve high conductivity and high temperature stability.

Furthermore, it is advantageous if the anatase crystalline phase at least predominates other crystalline phases, and preferably, if the anatase crystalline phase is the only existing crystalline phase of the titanium dioxide layer.

The term “X-ray amorphous” in the present context means that this phase does not exhibit any sharp X-ray diffraction maxima in an X-ray diffraction measurement.

Also, based on X-ray diffraction spectra, thoroughly investigated layers in particular exhibit the property that the substance amount fraction of the X-ray amorphous phase is greater than the substance amount fraction of the anatase crystalline phase. Other crystalline phases are preferably not present, as mentioned above, or are present in a smaller fraction as compared to the anatase phase. In other words, these layers are partially amorphous, with a minor proportion of an anatase phase. Also surprising herein is the good electrical conductivity of such layers, although amorphous materials typically exhibit a comparatively low conductivity.

For depositing the doped titanium dioxide layer as an anatase-containing layer of high temperature resistance, it has proved to be favorable to preheat the glass or glass-ceramic sheet to at least 250° C. during the deposition of the layer.

The invention will now be described by way of exemplary embodiments and with reference to the attached figures, wherein:

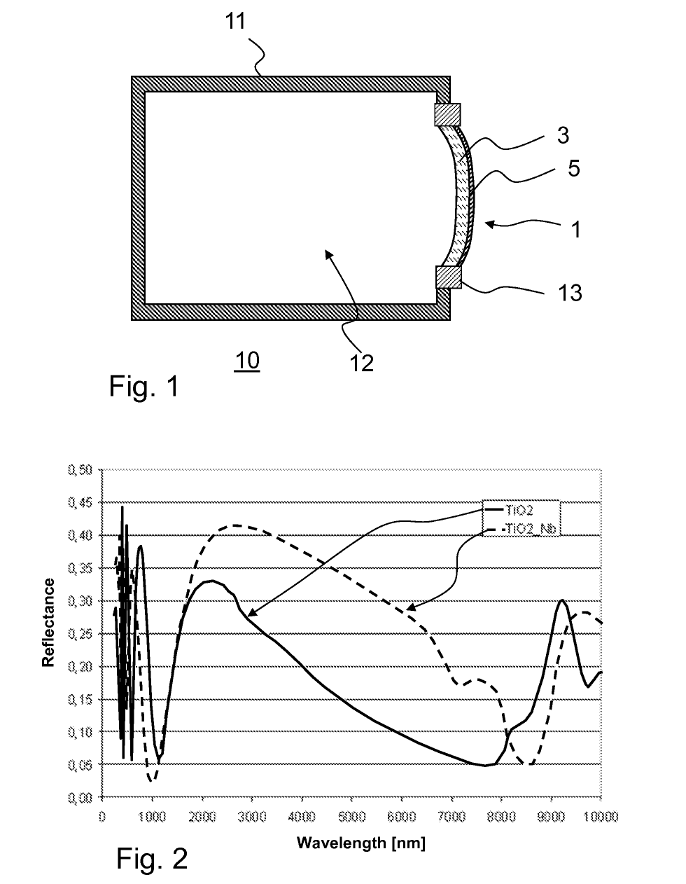

FIG. 1 shows a thermal process unit with heat protection glazing;

FIG. 2 illustrates measured spectra of reflectance as a function of wavelength;

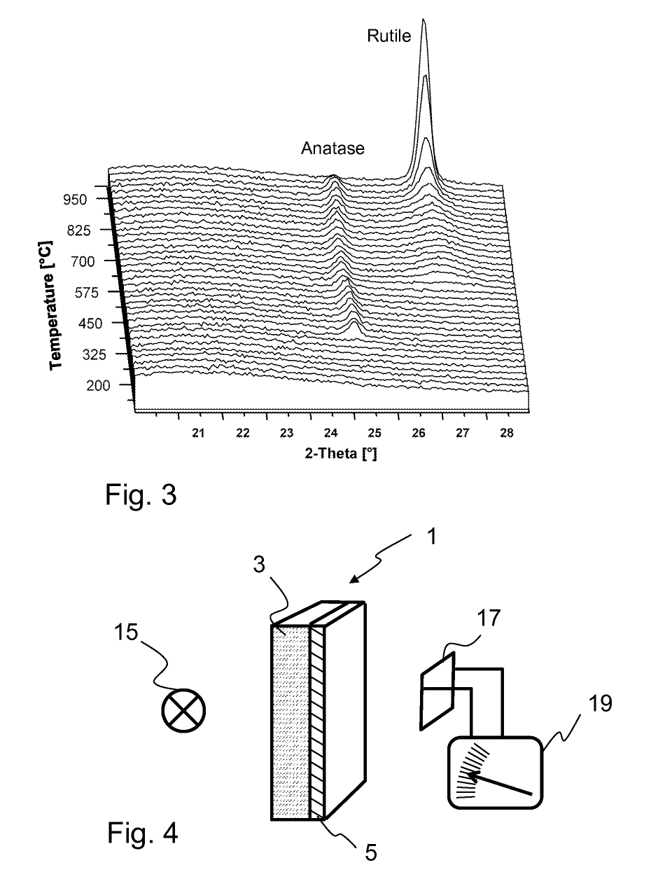

FIG. 3 shows X-ray diffraction spectra of titanium oxide layers;

FIG. 4 shows a measuring arrangement for measuring the efficiency of infrared reflecting coatings;

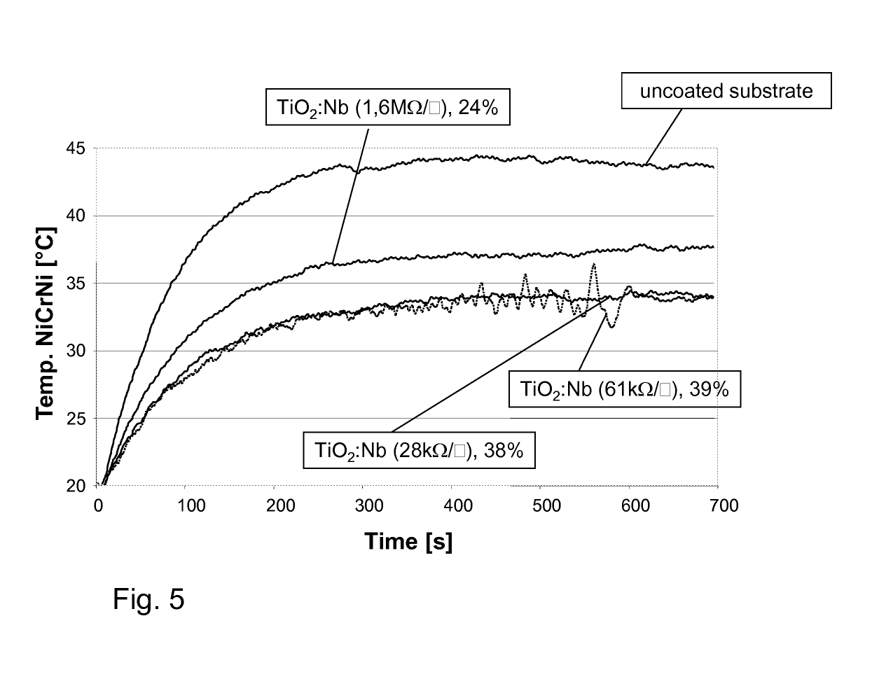

FIG. 5 shows temperature curves plotted in function of time using the measuring arrangement of FIG. 4;

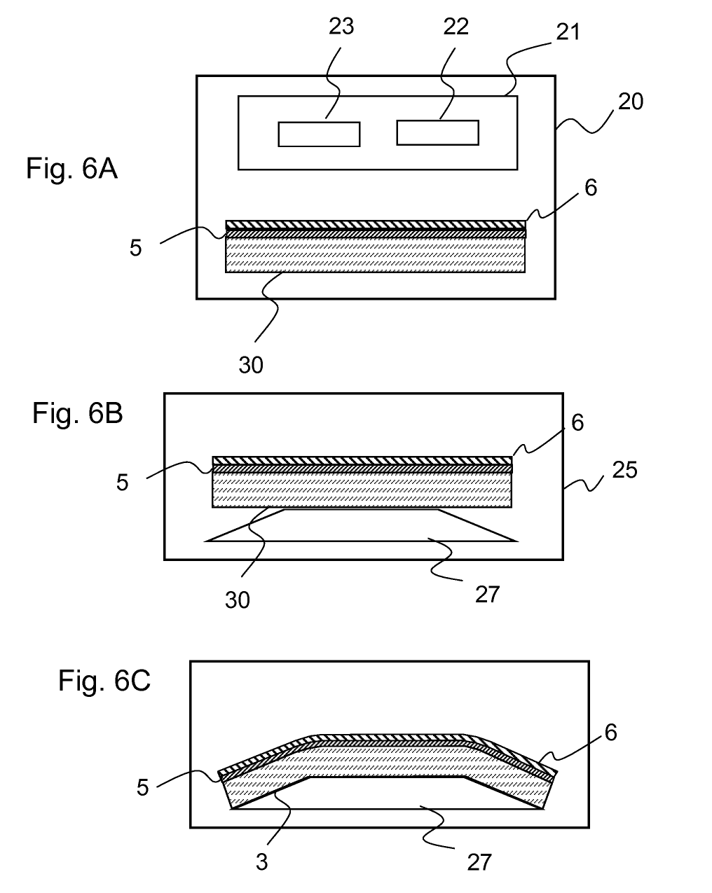

FIGS. 6A to 6C illustrate process steps for producing a heat protection glazing; and

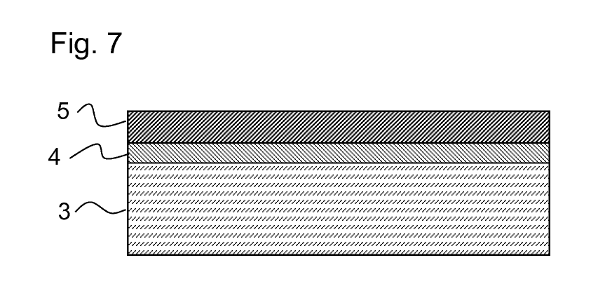

FIG. 7 shows an exemplary embodiment, in which an intermediate layer is deposited on the glass or glass-ceramic sheet.

FIG. 1 shows a thermal process unit 10 including a hot space 12 enclosed by a wall 11, and a window 13 closing the hot space 12, the window comprising a heat protection glazing 1 according to the invention. The thermal process unit may, for example, be an oven or a wood-burning stove. Heat protection glazing 1 comprising a glass or glass-ceramic sheet 3, on which a titanium dioxide layer 5 is deposited. The titanium dioxide layer 5 is doped with at least one transition metal compound, preferably a transition metal oxide, so that charge carriers are introduced into the conduction band and the titanium dioxide layer thus has a sheet resistance of not more than 2 MΩ. The glass or glass-ceramic sheet has a coefficient of thermal expansion α of less than 4.2*10⁻⁶/K, so that a high temperature stability is achieved, along with a good thermal shock resistance of the heat protection glazing.

The thickness of the titanium dioxide layer 5 is chosen such that in addition to the reflectance due to the free charge carriers there is an optical interference reflection effect. To this end, the thickness of the titanium dioxide layer is adapted to the spectrum of the incident infrared radiation. In particular, appropriately, the optical thickness is selected such that the wavelength of the maximum or center of gravity of the radiation spectrum is about to or equal to four times the layer thickness, so that the layer has a reflective optical interference effect on the highest-energy portion of the radiation spectrum. Preferably, for optical interference reflection of thermal radiation, the layer thickness is selected in a range from 80 to 250 nanometers, more preferably from 100 to 150 nanometers.

In the simple example shown in FIG. 1, the titanium dioxide layer is applied at least on the surface of the glass or glass-ceramic sheet which faces away from hot space 12. This embodiment of the invention is advantageous in order to reduce the emissivity of the sheet itself. During operation of thermal process unit 10, the heat protection glazing 1 itself often heats up to several hundred degrees. The inventive infrared reflecting filter coating on the surface facing away from hot space 12 then reduces the infrared radiation from heat protection glazing 1. In designing the layer thickness of titanium dioxide coating 5, the spectral distribution of the infrared radiation emitted from glass or glass-ceramic sheet 3 may particularly be considered. Typically, glass or glass-ceramic sheet 3 will emit infrared radiation of longer wavelengths as compared to hot space 12. Hence, in this case, depending on the desired efficiency the thickness of the layer may optionally be designed to be somewhat larger compared to an adaptation to the maximum of spectral emission from the hot space. The other hand, reflection is particularly effective especially in the long-wave infrared range, due to the electrical conductivity. Therefore, good reflectivity for the entire infrared radiation incident on titanium dioxide layer 5 is also obtained with a layer thickness designed for short-wave infrared, or near infrared. It will be apparent herefrom that a broadband reflection effect can be achieved by combining an optical interference layer and a layer reflecting due to free charge carriers.

Other than in the example shown in FIG. 1, the surface of glass or glass-ceramic sheet 3 facing hot space 12 may, alternatively or additionally, be provided with a titanium dioxide coating 5 according to the invention.

According to one embodiment of the invention, niobium is used as a transition metal, and the niobium is incorporated into the titanium dioxide layer in form of niobium oxide.

It could be demonstrated that the total reflection of heat radiation by a heat protection glazing according to the invention that includes a niobium-doped titanium dioxide layer can be enhanced by a factor of two as compared to a non-doped TiO₂ layer. FIG. 2 shows the corresponding spectra of reflectance.

In a practical test, experiments with niobium-doped TiO₂ have shown that the reflection of heat radiation can be increased by a factor of 2 as compared to pure TiO₂. This can be explained on the basis of the reflectance spectra of FIG. 2. The solid line in FIG. 2 represents the spectral reflectance of a glass sheet having a pure titanium dioxide coating. For comparison, the dashed line represents the spectral reflectance of a glass sheet having a titanium dioxide layer 5 according to the invention doped with four percent by weight of niobium oxide, of the same thickness. It is apparent from the spectra that the reflectivity can be significantly increased, with comparable layer thickness. In particular it can be seen that with the inventive coating a very broadband increase of reflectance in the range of wavelengths from 2000 nanometers to more than 7000 nanometers is achieved.

Moreover, when deposited on a heated substrate the layers exhibit an anatase crystalline structure and thus, in principle, offer the possibility to produce layer systems that are deformable during ceramization.

In this context, FIG. 3 shows X-ray diffraction spectra recorded from a niobium-doped titanium oxide layer after different thermal loads. As can be seen from the spectra that a significant formation of rutile in the doped layer only occurs above 900° C. Furthermore, it can be noted that the anatase phase only shows a weak diffraction peak over the background caused by an X-ray amorphous phase, as compared to the diffraction peak of rutile that forms at high temperatures.

The anatase diffraction peak, on the other hand, virtually does not exhibit any change in intensity across the entire temperature range in which the anatase phase occurs. This shows, first, that the X-ray amorphous phase predominates in the range up to about 900° C., and on the other hand that it is specifically the layer composition of an X-ray amorphous phase with a smaller fraction of the anatase phase which is very temperature stable up to temperatures of 900° C.

Two exemplary embodiments for producing a heat protection glazing according to the invention will now be explained below:

On a green state transparent glass ceramic, niobium-doped TiO₂ layers are sputter-deposited from a ceramic Nb₂O₅:TiO₂ target having a niobium doping of 4 percent by weight using a pulsed or non-pulsed magnetron sputter technique. For this purpose, the vitreous substrate placed on a carrier is first preheated to temperatures in a range from 250° C. to 400° C. to start the sputter process in a hot state.

In the subsequent sputter process, the layers are either produced in a pure DC mode (i.e. using direct current) or in a pulsed mode at frequencies from 5 to 20 kHz, so obtaining resistivities of about 10⁻³ Ωcm. This is accompanied by a formation of a plasma edge and thus an increase of reflectivity in the infrared.

Following subsequent cooling and processing such as cutting and edge grinding, the sheet is transformed, in a ceramizing process, into a HQMK (high quartz mixed crystals) and/or KMK (keatite mixed crystals) phase.

An optional deformation of the sheet is also accomplished during ceramizing. The Nb:TiO₂ coating may be provided on the surface facing the mold, or on the surface of the sheet facing away from the mold, or on both sides thereof.

In a second embodiment, niobium-doped TiO₂ is sputtered from a metallic Nb:Ti target having a doping of 6 percent by weight. In this case, the substrate is not additionally heated but is coated in a “cold state”. The coating process is carried out at medium frequencies in a range from 5 to 20 kHz with reactive gas control using plasma emission monitoring. The conductivity of the layers is obtained in a subsequent annealing process at about 400° C. By this process, likewise, resistivities in a range around 10⁻³ Ωcm may be achieved.

Generally, without being limited to the above exemplary embodiments, there are thus two preferred variations of producing the heat protection glazing: According to a first variation, the layer is deposited onto a heated glass or glass-ceramic sheet, preferably heated to at least 250° C. According to another variation, an amorphous layer is deposited, which is subsequently subjected to a tempering process so that an anatase phase is formed in the doped layer.

The good long-term stability of the infrared reflection properties of heat protection glazings according to the invention will now be explained with reference to FIGS. 4 and 5. FIG. 4 schematically shows a measuring arrangement for easily measuring the efficiency of infrared-reflective coatings. A glass or glass-ceramic sheet 3, in the example shown again a sheet coated on one surface thereof with a doped titanium dioxide layer 5, is disposed between a source of infrared radiation 15 and a temperature sensor, for example a surface thermocouple 17. After the infrared radiation source 15 has been switched on, the voltage of the surface thermocouple is measured and recorded using a measuring device 19. The infrared radiation transmitted through sheet 3 and incident on thermocouple 17 heats the thermocouple. Accordingly, in case of poorer infrared reflectivity of heat protection glazing 1, thermocouple 17 shows a higher temperature reading.

FIG. 5 shows temperature curves recorded as a function of time, measured at different sheets. During the measurement, the temperature sensor or in this case specifically a NiCr/Ni surface thermocouple 17 was spaced from the glass or glass-ceramic sheet 5 by 11 millimeters. As an infrared radiation source 15, a heated black plate was used at a distance of 18 millimeters to the glass or glass-ceramic sheet 5.

The substrates used for the measurement results shown in FIG. 5 were transparent lithium aluminosilicate glass-ceramic sheets which are marketed under the trade name ROBAX. As expected, the largest temperature rise occurs for the uncoated glass ceramic sheet. As the doped titanium dioxide layers 5, again, niobium-doped TiO₂ layers were deposited, with varying niobium contents and correspondingly different sheet resistances. Indicated in the figure for each of the curves are the sheet resistances of the layers as well as the percentage reduction of infrared transmission determined from the measurement. With a sheet resistance of 1.6 MΩ, the result is a reduction of infrared transmittance of 24% as compared to the uncoated substrate.

The other curves represent measurements on layers with a sheet resistance of 61 kΩ and 28 kΩ, respectively. Compared to the layer having a sheet resistance of 1.6 MΩ, there is another significant reduction in transmission resulting, which is due to the larger contribution of the reflection at the free charge carriers and thus to the doping.

However, the reflection properties of the layers are very similar, the layer with a sheet resistance of 28 kΩ exhibits a reduction of 38% in infrared transmission, which is only one percent better than that of the layer having a sheet resistance of 61 kΩ. Since at very low sheet resistances the transparency also decreases, it is advantageous for many applications to use coatings which have a sheet resistance of not less than 20 kΩ.

FIGS. 6A through 6C schematically illustrate the manufacturing of a heat protection glazing according to one exemplary embodiment. As already mentioned above, the coating may also be applied prior to the ceramization of a green glass and still performs its function after ceramization. Where appropriate, deformation is also possible in order to obtain a non-planar glass ceramic sheet that is provided with a high-temperature resistant infrared reflecting filter coating. FIG. 6A shows a green glass sheet 30 arranged in a vacuum chamber 20 of a sputter system. A magnetron sputter device 21 is arranged in vacuum chamber 20, including a target 22 doped with a transition metal, for example a niobium-doped titanium or titanium oxide target. By sputtering this target, a doped titanium dioxide layer 5 is deposited on green glass sheet 30.

As mentioned above, the invention in particular also relates to heat protection glazing exhibiting high transparency in the visible spectral range. Therefore, the doped titanium dioxide layers according to the invention preferably exhibit a mean transmittance of at least 60%, preferably at least 70%, in the visible spectral range. In order to further improve the transparency in the visible spectral range, according to one embodiment of the invention the titanium dioxide coating doped according to the invention may now be combined with an anti-reflective coating effective in the visible spectral range. Moreover, this is favorable because titanium dioxide has a very high refractive index, which results in strong and possibly disturbing reflections.

Particularly suitable is a low refractive index layer, preferably an SiO₂ layer with an optical thickness of λ/4 for a wavelength of the visible spectral range. For example, the layer may be designed as a λ/4 layer for green light, i.e. a wavelength of about 550 nanometers. In this case, for a λ/4 layer that is effective at a wavelength of 550 nanometers, a layer thickness of 550/(4*n) nanometers results, wherein n denotes the refractive index of the layer.

Such an anti-reflective coating may in particular be formed as a single layer. The thickness of such an anti-reflective single layer of SiO₂ which is deposited on the doped titanium dioxide layer according to the invention preferably ranges from 30 nanometers to 90 nanometers. In the example shown in FIG. 6A, a silicon or silicon oxide target 23 is arranged for this purpose. Using this target, a SiO₂ layer 6 of appropriate thickness is deposited on the doped titanium dioxide coating, by sputter device 21.

According to one embodiment of the invention, the doped titanium dioxide layer is deposited by medium-frequency sputtering. For this purpose, the sheet is thermally pretreated in a pretreatment step, preferably at a temperature from 250° C. to 450° C. for a period of at least 3 minutes, preferably for 10 minutes, or is continuously heated during the sputtering process to the temperatures indicated.

The temperature treatment is preferably performed under vacuum and results in evaporation of excess water from the substrate surface.

Subsequently, the sheet is transferred into vacuum chamber 20, and the titanium oxide layer is reactively deposited in a single or multiple pass along the sputter device. A pulse frequency may be set to between 5 and 10 kHz, and a high sputtering power of 15 W/cm² may be selected.

Due to the high particle flux achieved thereby, and under a low process pressure of about 10⁻³ mbar, dense titanium oxide layers with the above-mentioned properties can be produced.

The sputter process may be performed reactively from a metallic titanium target. A control scheme will be advantageous to stabilize the process.

Alternatively, sputtering may be performed using a ceramic TiO₂ target. In this case, complex controlling of the plasma intensity may then optionally be omitted.

When the green glass sheet has been coated, it is placed onto a carrier 27 in a ceramizing oven 25, as shown in FIG. 6B. The support surface of carrier 27 may be flat, for producing planar heat protection glazings. In the example shown, carrier 27 has a non-planar support surface comprised of a plurality of mutually angled surface portions.

Green glass sheet 30 is then heated in ceramizing oven 25 to the temperature required for ceramization, so that ceramization occurs in the green glass. As shown in FIG. 6C, the green glass sheet thereby softens so that it may adapt to the shape of the support surface of carrier 27 and is deformed accordingly. In the simplest case, shaping may be accomplished by the forces caused by the proper weight of green glass sheet 30. However, pressing or suction to the support surface, or a preceding hot bending, for example by means of gas burners, is also possible.

As a result, a non-planar glass ceramic sheet 3 is obtained provided with an infrared-reflective titanium dioxide coating 5 and an anti-reflection layer 6 effective in the visible spectral range. In similar manner the method is also suitable for producing heat protection glazings using glass sheets. In this case, the glass sheet with the deposited coating is heated and deformed without leading to ceramization.

In the embodiments of heat protection glazing described above, the titanium dioxide coating 5 doped with at least one transition metal compound was deposited directly on the surface of a glass or glass-ceramic substrate. According to yet another embodiment of the invention, an intermediate layer may be provided. In particular, in a modification of the invention, a preferably pure titanium dioxide coating which is not doped with a transition metal is used as the intermediate layer.

FIG. 7 schematically shows one embodiment of this type of heat protection glazing, in which a pure titanium dioxide coating is deposited on glass or glass-ceramic sheet 3 as an intermediate layer 4, and the titanium dioxide layer 5 which is doped with at least one transition metal compound is deposited onto this intermediate layer 4. Advantageously, the pure intermediate layer may serve as a seed layer for the infrared reflecting doped titanium dioxide layer, for instance to define and/or stabilize the morphology of the doped titanium dioxide layer. Other than in the schematic illustration of FIG. 7, intermediate layer 4 may be substantially thinner than doped titanium dioxide coating 5. Preferably, the thickness of intermediate layer 4 is not more than one fifth of the thickness of doped titanium dioxide coating 5.

The intermediate layer may in particular be produced using a deposition method as described in German Patent Application No. 10 2009 017 547. The disclosure of this application with respect to the deposition method for producing a titanium dioxide intermediate layer is fully incorporated in the present application by reference. Accordingly, the glass or glass-ceramic sheet is preferably heated prior to applying the intermediate layer, in particular to between 200° C. and 400° C., in order to improve the adhesive strength of the intermediate layer. The intermediate layer is preferably produced by magnetron sputtering, reactive sputtering using a metallic titanium target being particularly suitable. For depositing, a pulse frequency of the electromagnetic field may be selected in a range from 5 to 10 kHz, and a high sputtering power of 10 W/cm² or more may be selected.

### LIST OF REFERENCE NUMERALS

1 Heat protection glazing

3 Glass or glass-ceramic sheet

4 Intermediate layer

5 Titanium dioxide coating

10 Thermal process unit

11 Wall of 12

12 Hot space

13 Window

15 Infrared radiation source

17 Surface thermocouple

19 Measuring device

20 Vacuum chamber

21 Magnetron sputter device

22 Nb:Ti target

23 Si target

25 Ceramizing oven

27 Support for 30

30 Green glass sheet

1-18. (canceled)

19. A thermal process unit comprising:
a hot space and a window closing the hot space, the window comprising a heat protection glazing with a high-temperature infrared reflecting filter coating, wherein the heat protection glazing comprises a glass or glass-ceramic sheet having a linear coefficient of thermal expansion a of less than 4.2*10⁻⁶/K, wherein at least one surface of the glass or glass-ceramic sheet is coated with a titanium dioxide layer which is doped with a compound of at least one of transition metal selected from the group consisting of Nb, Ta, Mo, and V so that the titanium dioxide layer has a sheet resistance of not more than 2 MW, and wherein the titanium dioxide layer has a layer thickness of an optical thickness corresponding to a quarter wavelength of the maximum of a black body radiator at a temperature between 400° C. and 3000° C.

20. The thermal process unit as claimed in claim 19, wherein the titanium dioxide layer is doped with a transition metal oxide.

21. The thermal process unit as claimed in claim 19, wherein the titanium dioxide layer comprises at least one crystalline phase.

22. The thermal process unit as claimed in claim 21, wherein the titanium dioxide layer comprises an X-ray amorphous phase.

23. The thermal process unit as claimed in claim 21, wherein the titanium dioxide layer comprises an anatase crystalline phase.

24. The thermal process unit as claimed in claim 23, wherein the titanium dioxide layer further comprises an X-ray amorphous phase.

25. The thermal process unit as claimed in claim 24, wherein the X-ray amorphous phase has a substance amount fraction that is greater than a substance amount fraction of the anatase crystalline phase.

26. The thermal process unit as claimed in claim 23, wherein the anatase crystalline phase at least predominates other crystalline phases.

27. The thermal process unit as claimed in claim 23, wherein the anatase crystalline phase is the only existing crystalline phase of the titanium dioxide layer.

28. The thermal process unit as claimed in claim 19, further comprising a pure titanium dioxide coating as an intermediate layer on the glass or glass-ceramic sheet, wherein the titanium dioxide layer is deposited on the intermediate layer.

29. The thermal process unit as claimed in claim 19, further comprising a single anti-reflective SiO₂ layer deposited on the titanium dioxide layer, the single anti-reflective SiO₂ layer having a layer thickness ranging from 30 nanometers to 90 nanometers.

30. The thermal process unit as claimed in claim 19, wherein the titanium dioxide layer is disposed at least on the surface of the glass or glass-ceramic sheet facing away from the hot space.

31. A method for producing a heat protection glazing of a thermal process unit, comprising:
depositing a titanium dioxide layer on a glass or glass-ceramic sheet to form a coated sheet, the titanium dioxide layer being doped with a compound of at least one of transition metal selected from the group consisting of Nb, Ta, Mo, and V so that the titanium dioxide layer has a sheet resistance of not more than 2 MW and an optical thickness corresponding to a quarter wavelength of a maximum of a black body radiator at a temperature between 400° C. and 3000° C.

32. The method as claimed in claim 31, wherein the step of depositing the titanium dioxide layer comprises sputtering.

33. The method as claimed in claim 31, further comprising ceramizing the coated sheet to so that a glass-ceramic sheet is obtained, the glass-ceramic sheet having a linear coefficient of thermal expansion α of less than 4.2*10⁻⁶/K.

34. The method as claimed in claim 31, wherein the titanium dioxide layer is deposited with a layer thickness ranging from 80 to 250 nanometers.

35. The method as claimed in claim 31, further comprising preheating the glass or glass-ceramic sheet to at least 250° C. before depositing the titanium dioxide layer.

36. The method as claimed in claim 35, wherein the titanium dioxide layer is deposited as an anatase-containing layer.

37. The method as claimed in claim 31, further comprising deforming the coated sheet.

38. The method as claimed in claim 31, wherein the titanium dioxide layer is doped with a transition metal compound in a range from 1 to 10 percent by weight.
